(19) United States
(12) Patent Application Publication
(10) Pub. No.: US 2020/0043109 A1
(43) Pub. Date: Feb. 6, 2020

(54) REAL TIME APPLICATION FOR BUYING PROPERTY

(71) Applicants: Amos Kardonchik-Koren, Tucson, AZ (US); Justin Michael Bentley, Tucson, AZ (US)

(72) Inventors: Amos Kardonchik-Koren, Tucson, AZ (US); Justin Michael Bentley, Tucson, AZ (US)

(21) Appl. No.: 16/527,603

(22) Filed: Jul. 31, 2019

Related U.S. Application Data
(60) Provisional application No. 62/713,359, filed on Aug. 1, 2018.

(51) Int. Cl. G06Q 50/16; G06Q 30/06

(52) U.S. Cl. CPC G06Q 50/16; G06Q 30/0641

(57) ABSTRACT

A system for facilitating real time buying of a property, comprises a server, comprising a real-estate multiple listing service database, comprising data about at least one property, comprising at least data about a status of “active” or “under contract”, a location, comprising at least GPS coordinates of the property, and instructions for showing the property and a plurality of agent profiles, comprising at least the agent's name and the agent's location.

### CROSS-REFERENCES TO RELATED APPLICATIONS

This application is a non-provisional and claims benefit of U.S. Patent Application No. 62/713,359, filed Aug. 1, 2018, the specification(s) of which is/are incorporated herein in their entirety by reference.

### BACKGROUND OF THE INVENTION

The BLIP application is intended to open up the market and level the playing field to real estate agents who want to offer quality service in real time to the public, while avoiding excessive monthly lead generation fees that companies like Zillow and Trulia are charging. Instead of buying expensive “blocks of leads” in pre-determined zip codes, the prospective buyers who are touring in a certain part of town can see active agents in their immediate area who are available at a moment's notice to show a property. These agents will communicate directly with the prospective buyers on an a la carte type basis. This system eliminates the need for complicated scheduling, especially in a tight market where time is of the essence (since this is a strong seller's market, listings sell quickly, and it is vital that buyers can access the home quickly so they don't lose on the opportunity to bid on the home). It also allows agents better control of their time and lets them choose how productive they want to be (they can choose to be “on call” or off) and work in any part of the city, not having to relay on buying zip codes to market in. Now they can market to the entire city. Wherever they go, if an agent chooses to be on call, they will be seen on the application, and a buyer who wants to see a home in their area will be able to request that the agent show him a home in the area.

It will of course be up to the real estate agent to pre-qualify and nurture the client relationship. Since there is strong connection between number of showings and sale price of the property, the ease of increased showing traffic on a property will also help sellers sell the home faster and at a balanced price that is a true reflection of market conditions.

BLIP is a revolutionary mobile phone application intended to connect the public (home buyers) with real estate sales professionals in real time. Using geo-location (mapping) software and connection to the local real estate Multiple Listing Service (MLS), buyers will be able to see real estate agents who are near a property or properties they wish to see and request that agent, or another nearby agent, to show the home. The available agent who is closest to that buyer and accept the service request will coordinate the showing of the home as well as any additional nearby homes of interest, identified by the buyer. The public (the buyer) does not pay any fee for the service. This application will level the playing field to the agents by eliminating the need for them to spend thousands of dollars to buy leads (zip codes) and provide greater and more balanced service to the public from real estate agents who are wanting to serve the public in real time. Sellers will also benefit from added exposure to buyers, which in turn could help the home sell faster and for more money (due to higher levels of market exposure).

### BRIEF DESCRIPTION OF THE DRAWINGS

The features and advantages of the present invention will become apparent from a consideration of the following detailed description presented in connection with the accompanying drawings in which:

FIG. 1 shows an example representation of an environment for facilitating real time buying of property, in accordance with an example embodiment of the invention;

FIG. 2A is a flow diagram of a method for facilitating real time buying of property by a buyer at home, in accordance with an example embodiment of the invention;

FIG. 2B is a flow diagram of a method for facilitating real time buying of property by a buyer at property, in accordance with an example embodiment of the invention;

FIG. 3 illustrates a computing device capable of implementing the various embodiments of the present invention;

FIG. 4 illustrates an embodiment of a method for facilitating real time buying of property.

The drawings referred to in this description are not to be understood as being drawn to scale except if specifically noted, and such drawings are only exemplary in nature.

### DESCRIPTION OF PREFERRED EMBODIMENTS

In a primary embodiment, the system (400) for facilitating real time buying of a property, comprises a server (401), comprising a real-estate multiple listing service database (407), comprising data about at least one property, comprising at least data about a status of “active” or “under contract”, a location, comprising at least GPS coordinates of the property, and instructions for showing the property and a plurality of agent profiles (430), comprising at least the agent's name and the agent's location. The server has a processor capable of executing computer instructions, and is configured to execute computer implemented instructions comprising instructions for receiving GPS coordinates (202) from a client application of a buyer (416) wherein the GPS coordinates represent the buyer's physical location, instructions for searching the database (407) using the GPS coordinates (203), instructions for receiving an identification of at least one property of interest selected by the client, instructions for interfacing with the client application (402) for receiving contact information from the buyer (405), instructions for interfacing with an agent application (408) to transmit a notification to the agent application that a buyer has requested to see the property of interest, instructions for accepting payment from the agent application (408), instructions for transmitting the contact information of the buyer to the agent application (408), and instructions for retrieving the instructions to show the property of interest from the real-estate multiple listing service database, and transmitting the instructions to the agent application (408).

In the primary embodiment the system further comprises the client application, operatively connected to the server via a network, comprising a user interface (403), comprising means for the buyer (406) to fetch the GPS coordinates of the buyer, transmit the GPS coordinates of the buyer to the server (202), and receive data about at least one property (203). The client application comprises means for displaying the data about at least one property matching the search parameters and/or the GPS coordinates of the buyer at property, means for a buyer (405) to select a property of interest, and transmit the selection of the property of interest to the server. The client application further comprises means for entering the buyer's contact information.

In the primary embodiment, the agent application (408) is operatively connected to the server via the network, comprising a user interface (409) comprising, means for receiving the notification that a buyer is interested in viewing the property of interest, means for displaying the property of interest and an option to purchase the buyer's contact information, means for purchasing the contact information of the buyer (405) in real time, comprising transmitting payment information to the server; and means for receiving the contact information of the buyer.

In some embodiments, the buyer is sitting at his home, office, or a coffee shop doing a search by entering parameters of a desired home into the application. The application returns only active listings that match the parameters, within a certain radius. The buyer selects the top three homes he wants to see and sends a request to nearby agents to show the property or properties in order of importance. The buyer also discloses his loan application status (has he applied for a loan, if he is working with a lender, and or if he needs one to contact him).

In the primary embodiment of the system when the buyer at a property (406) searches for the property listing at his location the client application retrieves the GPS coordinates of the buyer's location and sends the GPS coordinates to the server, whereupon the server communicates with the real-estate multiple listing service database (407) to retrieve data about at least one properties matching the GPS coordinates, wherein if there is no property with an active listing within the initial radius of the buyer's location the server searches for properties within a radius of the buyer's location, wherein the server increases the radius until at least one properties are retrieved, wherein the data about at least one properties is displayed to the buyer at the property (406), wherein the buyer selects at least one properties of interest, wherein the server searches the database (407) to retrieve a plurality of agents available to show the at least one property, wherein the server pings at least one agent with a lead of the buyer, wherein the lead of the buyer comprises the buyer's property of interest, wherein when the agent (410, 412, 414) receives the notification from the server, the agent purchases the contact information of the buyer, whereupon the server communicates the information of the buyer, instructions to show the property of interest, and a detailed view of the property of interest from the real-estate multiple listing service database to the agent application (408). In some embodiments, the prospective buyer can make a search by manually entering the physical address of a property. In some embodiments, the prospective buyer can enter an address of a property of interest, and the server communicates with the real-estate multiple listing service databases (407) to retrieve data about at least one property matching the address entered.

In some embodiments the processor is further configured to execute instructions comprising instructions for receiving a plurality of search parameters for the property from the client application (420), wherein the search parameters comprise data describing at least one property that the buyer is searching for, and instructions for searching the database using the plurality of search parameters, to retrieve a plurality of properties matching the search parameters. In some embodiments, there may be an offer to limit the number of properties returned from which the buyer can elect up to three. This will also allow the agent to form a relationship and will not limit the agent from other activities for that day.

In some embodiments the client application further (402) comprises means for a buyer at home (404) to enter a plurality of search parameters for a property (420) to be purchased, means for interfacing with the server (401), to transmit the search parameters and receive data about a plurality of properties from the server, and means for allowing the buyer to select whether to search using GPS coordinates or search parameters or both.

In some embodiments, the buyer at home (404) enters search parameters into the client application (402), whereupon the client application transmits the search parameters to the server (401), wherein the search parameters may include a manually entered GPS location, wherein the server searches the database (407) for properties with data matching the search parameters, and wherein the server transmits the data about at least one properties (420) matching the search parameters to the client application (402).

In some embodiments, when the properties are displayed by the client application (402), when a status of the property is “active”, the property is indicated by a first color; wherein when the status of the property is “under contract”, the property is indicated by a second color. In some embodiments, the client/buyer can only select to show active listings.

In some embodiments the server searches for agents whose location is in the closest proximity to the location of the property of interest, wherein the server sorts the agents according to distance from the buyer and selects at least one agent according to closest proximity to the buyer.

Tin some embodiments the price of the contact information of the buyer varies based on the price of the property.

In some embodiments, the quality of the lead of the buyer determines the price of the lead of the buyer. In some embodiments, quality of lead is determined by the information the client discloses such as their loan status, are they starting or do they have a lender (identify lender from dropdown menu), the price point of the home, the time of day and day of the week the showing is requested (E.g. “Peak hours” and showing on Monday as compared to showing on Saturday).

In some embodiments, multiple buyers looking in an area on a given time of day also determines the price of the contact information of the buyer.

In some embodiments, when showing the property requires an advance notice, multiple other properties in the area of the property of interest are displayed by the client application.

In some embodiments, the client application further comprises means for adding to the data of the property at least one comments or reviews comprising neighborhood amenities and benefits of the property.

In some embodiments, the agent application (408) further comprises means for retrieving the agent's profile information (430) from the database and displaying the profile information of the agent, means for editing the profile information about the agent, means for the agent to enter search parameters for searching the database (407), means for interfacing with the server to transmit search parameters to the database and receive the data about at least one properties (420) from the database, means for displaying data about the at least one properties of the database, and means for adding at least one piece of market information and reviews of the neighborhood of the property to the data about the at least one property of the database.

In an alternative embodiment, the property profile of the database comprises a property schedule, wherein the schedule comprises dates and times which are available to show the property and any scheduled showings, wherein the agent profile (430) of the database further comprises an agent schedule, wherein the agent schedule comprises dates and times the agent is available to show properties, and any scheduled showings, wherein the processor of the server (401) is further configured to execute instructions comprising means for searching the database to retrieve at least one agents available to show the at least one properties at a selected date and time, according to the schedule of the agents' profiles, means for transmitting the selected date and time of the property of interest to the agent application, wherein the notification further comprises the selected date and time; and means for adding a scheduled showing to the schedule of the property profile at the selected date and time.

In some embodiments, the client application (402) further comprises means for displaying the property schedule of the at least one properties and means for selecting an available date and time from the schedule, wherein when the buyer selects a date and time of a schedule of a property, the property selected is consider the property of interest.

In some embodiments the agent application (408) further comprises means for displaying the buyer's selected date and time, wherein the notification to the agent application further comprises the desired showing time, wherein when the buyer selects a date and time, the date and time and the property of interest are transmitted to the server, whereupon the server (401) searches the database to identify at least one agents (430) available at the selected date and time, wherein the server pings the at least one agents with the property of interest and selected date and time, wherein if the agent purchases the lead of the buyer, the schedule of the property of interest is edited to add the showing.

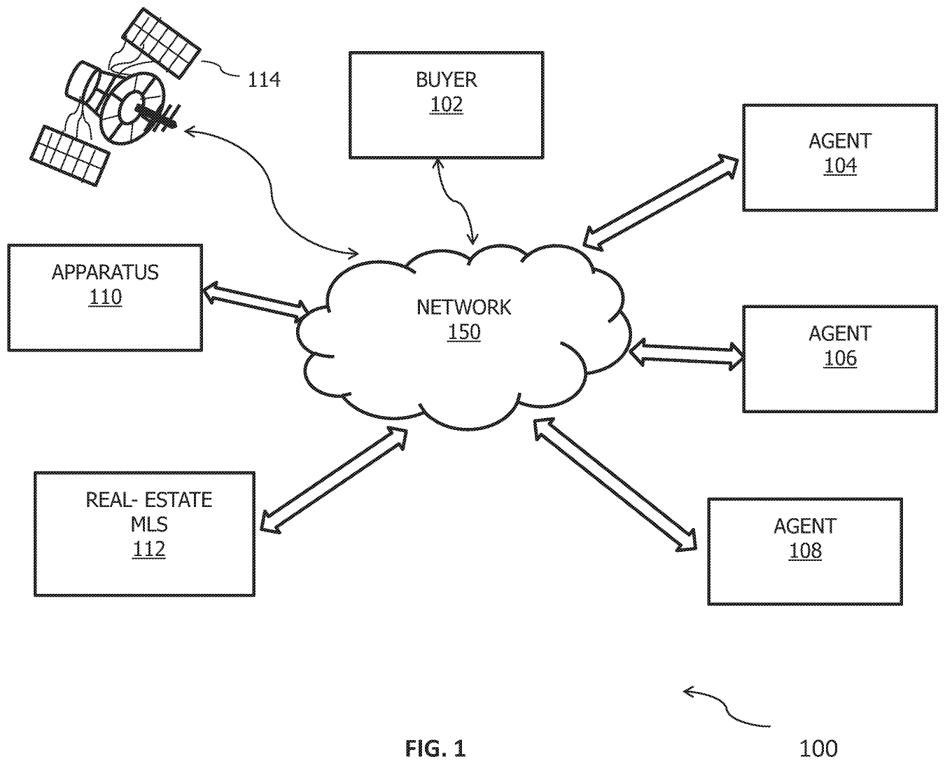

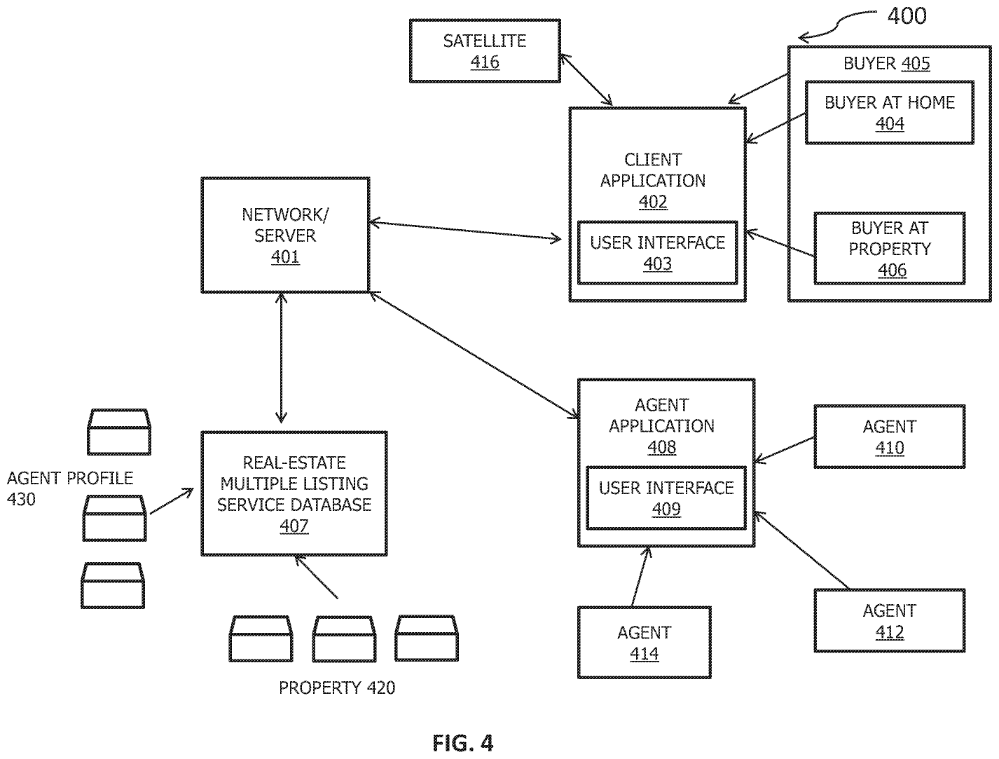

The best and other modes for carrying out the present invention are presented in terms of the embodiments, herein depicted in FIGS. 1 to 4. The embodiments are described herein for illustrative purposes and are subject to many variations. It is understood that various omissions and substitutions of equivalents are contemplated as circumstances may suggest or render expedient, but are intended to cover the application or implementation without departing from the spirit or the scope of the present invention. Further, it is to be understood that the phraseology and terminology employed herein are for the purpose of the description and should not be regarded as limiting. Any heading utilized within this description is for convenience only and has no legal or limiting effect. The terms “a” and “an” herein do not denote a limitation of quantity, but rather denote the presence of at least one of the referenced item.

As used herein, the term “about” refers to plus or minus 10% of the referenced number.

Referring to FIGS. 1-4, the present invention features a method and apparatus for facilitating real time application for buying property. Currently, no mechanism exists to connect the agents with the buyer who are shopping for a property in real time. Various embodiments disclosed herein provide a platform-agnostic utility for buying property in real time by connecting a buyer to the agent. Using Geo-location (mapping) software and connection to the local real estate multiple listing service (MLS), a buyer can see nearby agents and request to see the property of interest. The available agent who is in close proximity to the buyer will be contacted to show the property as well as any additional properties of interest to the buyer. The agents have to pay a fee for monthly access membership and a fee for each lead of the buyer that the agent buys. The agent can buy the lead of the buyer when he responds to a call to show a property to the buyer. The buyer does not pay any fee for the service. The present invention levels the playing field to the agents by eliminating the need for them to spend large sum of money to buy leads and provide better and balanced service to the public.

FIG. 1 shows an example representation of an environment 100 for facilitating the real time application for buying property, in accordance with an example embodiment of the invention. The environment 100 is depicted to include a buyer 102; a plurality of agents 104, 106 and 108; an apparatus 110; a real-estate MLS 112; a Global Positioning System (GPS) satellite 114; and a network 150. The environment 100 is exemplarily depicted to display only three agents, however, it is noted that the environment 100 may include fewer or more agents.

The buyer 102 and the agents 104,106, and 108 may use their respective electronic devices to access the online/Web interface of the present invention over a communication network, such as a network 150. The network 150 may include wired networks, wireless networks and combinations thereof. Some non-limiting examples of the wired networks may include Ethernet, local area networks (LANs), fiber-optic networks, and the like. Some non-limiting examples of the wireless networks may include cellular networks like GSM/3G/4G/5G/LTE/CDMA networks, wireless LANs, Bluetooth, Wi-Fi or ZigBee networks, and the like. An example of the combination of wired and wireless networks may include the Internet. Accordingly, the buyer 102 may browse through a list of properties on the apparatus 110 using the local real-estate MLS 112 and GPS satellite 114 and may connect to the agents 104, 106 and 108 over the network 150 to see the property of interest.

The apparatus 110 is configured to support real time shopping of property by the buyer 102 by connecting to the agents 104,106 and 108 to see the property of interest. To that effect, the apparatus 110 is configured to be in operative communication with real-estate MLS 112 over the network 150 to provide real time list of properties to the buyer 102 based on a plurality of search parameters set by the buyer 102. The apparatus 110 may be embodied as remote machine, such as for example a Web server, including computer program instructions/smart phone application configured to facilitate real time buying of property. In at least one example embodiment, the apparatus 110 may be configured to display an option (for example, in the form of a widget, overlay or an icon) for the buyer 102 to browse different properties and for the agents 104, 106 and 108 to connect to the buyer 102 on the online interface.

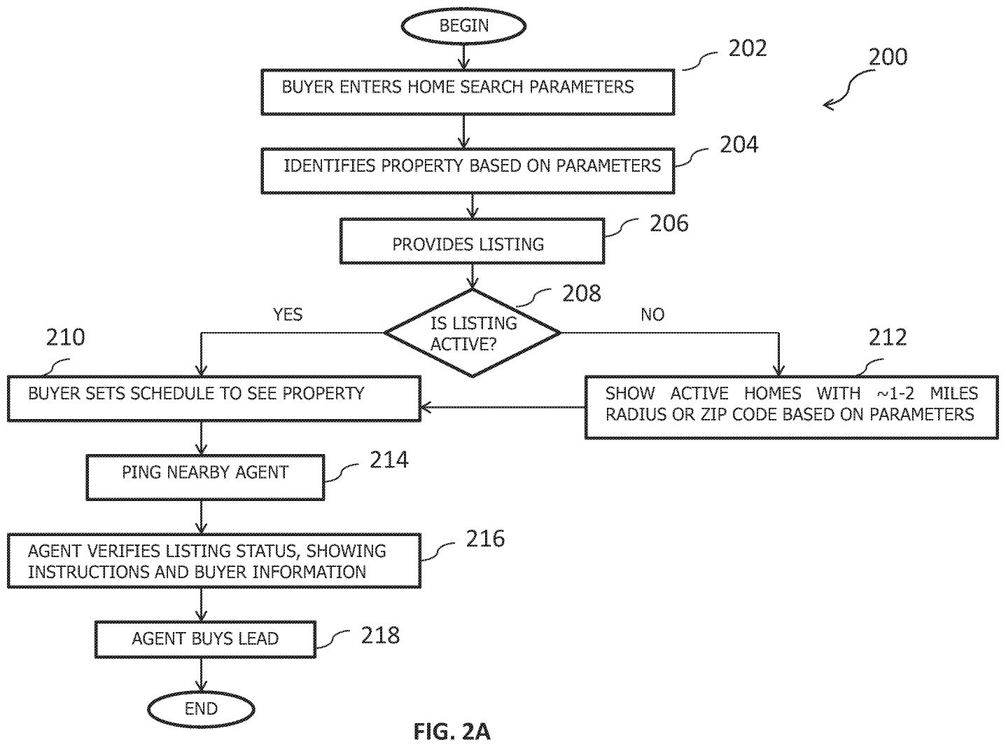

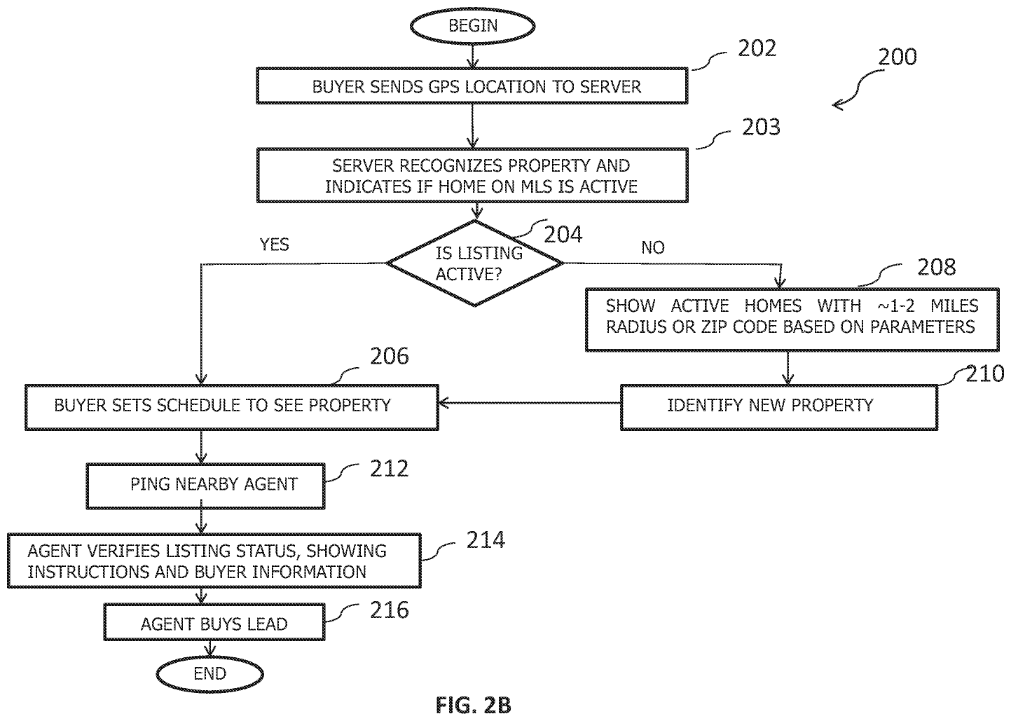

FIG. 2A is a flow diagram of a method 200 for facilitating real time buying of property by a buyer at home in accordance with an example embodiment. The various steps and/or operations of the flow diagram, and combinations of steps/operations in the flow diagram, may be implemented by, for example, hardware, firmware, a processor, a circuitry and/or by the apparatus 110 of the present technology and/or by a different device associated with the execution of software that includes one or more computer program instructions. The method starts at operation 202.

At 202, the buyer 102 enters personal information and basic search parameters for the property on a user interface (UI) associated with a client application for the buyer 102, such as full name, phone number, current address, e-mail, loan status (working with a lender/need a lender, type of loan), desired move-in date, type of property, number of bedrooms/bathrooms, number of garage spaces, single or multi-story, zip code, price range, or the like. Depending on the client input the UI can show pop ups recommending certain loan programs the buyer 102 should inquire about or recommend two or three lenders that can provide information on advantageous loan programs. These vendors will pay a fee per lead. As explained with reference to FIG. 1, an apparatus, such as the apparatus 110, may associate plug-ins and APIs, which may be activated upon selection of the option to search for the property. The API calls may cause the apparatus to display an UI enabling the buyer to provide the details mentioned above.

At 204, multiple properties are identified based on the search parameters given by the buyer 102.

At 206, display of a UI is configured to provide listing of the multiple identified properties along with the details to the buyer 102.

At 208, if the UI displayed to the buyer 102 is showing the listing of properties for sale/rent that have active status, the buyer 102 then selects the property interested in seeing.

At 212, the UI is configured to display a list of other active properties within ˜1-2 miles radius or zip code based on the search parameters provided by the buyer 102, if the UI displayed to the buyer 102 is showing the listing of properties for sale/rent that have status of under contract (step 208). At 212, in the event the buyer 102 enters a specific address of a home for sale, and the system shows that it is under contract, the system will automatically bring up other homes with similar features within 1-2 mile radius that are active for sale.

At 210, display of the UI is configured to provide list of all the “on call” agents 104, 106 and 108 that are available to show the property to the buyer 102. The buyer 102 confirms the request and sets a schedule to see the property of interest.

At 214, display of the UI is configured to ping the closest agent amongst the agents 104,106 and 108 to show the property to the buyer 102.

At 216, the agent accepts the lead call on UI associated with an agent application for the agents 104,106 and 108. The agent verifies the listing status, showing instructions and buyer information for the property of interest.

At 218, display of the UI is configured to charge the agent for accepting the order and to pay a fixed price for accepting the lead. The price of the lead varies based on the price of the property and the quality of the lead. When there are multiple buyers looking in the area on a given time of day, also determines the price of the lead of the buyer. After the payment, the UI is configured to display the full details of the buyer information. The agent then contacts the buyer 102 and coordinates the schedule to show the property. In case, the agent cannot get into the property due to longer showing instructions, the agent application will identify other active homes within ˜1-2 miles radius that are available for show. The method 200 ends at 218.

In some other embodiment, FIG. 2B is a flow diagram of a method 200 for facilitating real time buying of property by a buyer at property in accordance with an example embodiment. The method starts at operation 202.

At 202, when the buyer 102 drives by the property interested in seeing, display of the UI is configured to recognize the GPS coordinates of the property and provides the details of the property with further indication on whether the property on the real-estate MLS 112 has active status on listing.

At 204, if the UI displayed to the buyer 102 is showing the property of interest has active status, it is indicated by a color (e.g. yellow).

At 208, the UI is configured to display a list of other active properties within ˜1-2 miles radius or zip code based on the search parameters provided by the buyer 102, if the UI displayed to the buyer 102 is showing the property of interest has status of under contract and is indicated by another color (e.g. blue) (step 208).

At step 210, display of the UI is configured to identify the new property and provide details to the buyer 102.

At 206, if the buyer 102 is interested in seeing the property, then the buyer 102 enters the personal information as mentioned above on the UI associated with the client application. The buyer 102 may also enter his personal information and parameters in to the UI so it can be saved and remember him for future requests. This system may also alert the buyer 102 of other homes that fit theses parameters as they come onto the market.

At 212, display of the UI is configured to provide list of all the “on call” agents 104, 106 and 108 that are available to show the property to the buyer 102. The buyer 102 confirms the request and sets the schedule to see the property of interest. Further, display of the UI is configured to ping the closest agent amongst the agents 104,106 and 108 to show the property to the buyer 102.

At 214, the agent accepts the lead call on UI associated with the agent application for the agents 104,106 and 108. The agent verifies the listing status, showing instructions and buyer information for the property of interest.

At 216, display of the UI is configured to charge the agent for accepting the order and to pay a fixed price for accepting the lead. After the payment, the UI is configured to display the full details of the buyer information. The agent then contacts the buyer 102 and coordinates the schedule to show the property. In case, an advance notice is required to show the property, the agent application will identify 2-3 other active homes for viewing. The method 200 ends at 216.

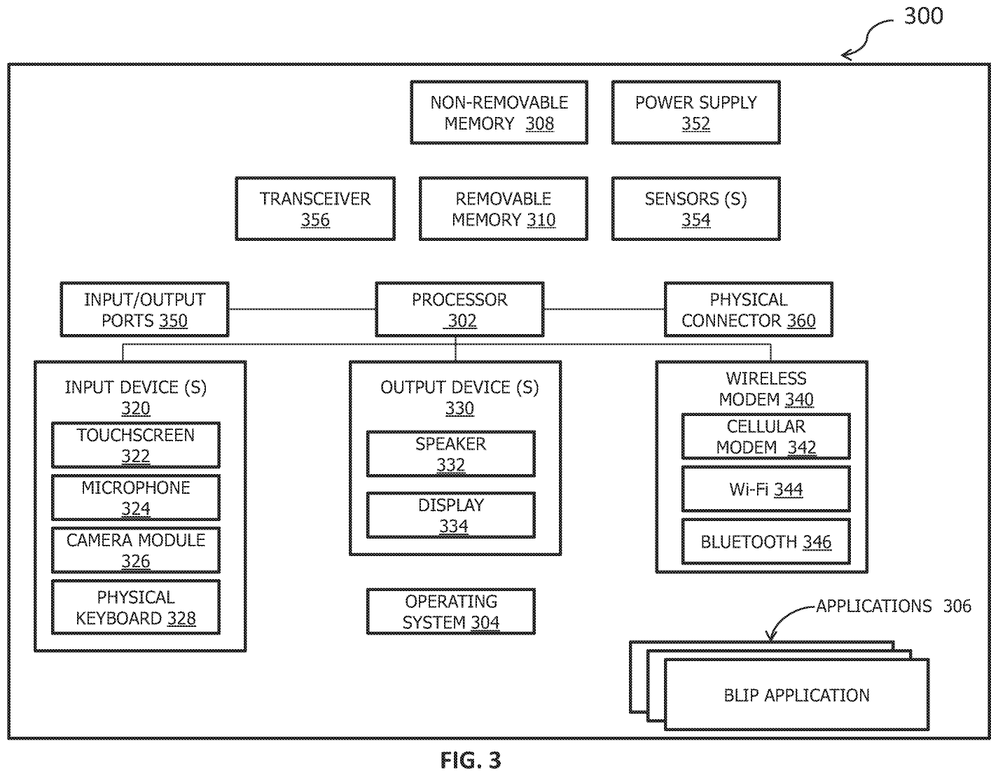

Referring now to FIG. 3, an example representation of a computing device 300 capable of implementing the various embodiments of the present invention is shown. In an embodiment, the various operations performed by the apparatus 110 may be implemented using an application in a computing device, such as the computing device 300. For example, the computing device 300 may correspond to a device corresponding to a buyer or a device corresponding to an agent. The computing device 300 is depicted to include one or more applications 306, including an application for real time buying of property, which serves as an instance of the application downloaded from the apparatus 110 and capable of communicating through API calls with the apparatus 110 to facilitate real time buying of property.

It should be understood that the computing device 300 as illustrated and hereinafter described is merely illustrative of one type of device and should not be taken to limit the scope of the embodiments. As such, it should be appreciated that at least some of the components described below in connection with that the computing device 300 may be optional and thus in an example embodiment may include more, less or different components than those described in connection with the example embodiment of the FIG. 3. As such, among other examples, that the computing device 300 could be any of a mobile electronic devices, for example, cellular phones, tablet computers, laptops, mobile computers, personal digital assistants (PDAs), mobile televisions, mobile digital assistants, or any combination of the aforementioned, and other types of communication or multimedia devices.

The illustrated computing device 300 includes a controller or a processor 302 (e.g., a signal processor, microprocessor, ASIC, or other control and processing logic circuitry) for performing such tasks as signal coding, data processing, image processing, input/output processing, power control, and/or other functions. An operating system 304 controls the allocation and usage of the components of the computing device 300 and support for one or more applications programs (see, applications 306), such as real time buying of property, that implements one or more of the innovative features described herein. In addition to real time application for buying property, the applications 306 may include common mobile computing applications (e.g., telephony applications, email applications, calendars, contact managers, web browsers, messaging applications) or any other computing application. The real time application of buying property, in at least one example embodiment, may be configured to provide the logic to facilitate real time buying of property, as explained with reference to FIGS. 1 to 2.

The illustrated computing device 300 includes one or more memory components, for example, a non-removable memory 308 and/or removable memory 310. The non-removable memory 308 can include RAM, ROM, flash memory, a hard disk, or other well known memory storage technologies. The removable memory 310 can include flash memory, smart cards, or a Subscriber Identity Module (SIM). The one or more memory components can be used for storing data and/or code for running the operating system 304 and the applications 306.

The computing device 300 can support one or more input devices 320 and one or more output devices 330. Examples of the input devices 320 may include, but are not limited to, a touch screen 322 (e.g., capable of capturing finger tap inputs, finger gesture inputs, multi-finger tap inputs, multi-finger gesture inputs, or keystroke inputs from a virtual keyboard or keypad), a microphone 324 (e.g., capable of capturing voice input), a camera module 326 (e.g., capable of capturing still picture images and/or video images) and a physical keyboard 328. Examples of the output devices 330 may include, but are not limited to a speaker 332 and a display 334. Other possible output devices (not shown in the FIG. 3) can include piezoelectric or other haptic output devices. Some devices can serve more than one input/output function. For example, the touchscreen 322 and the display 334 can be combined into a single input/output device.

A wireless modem 340 can be coupled to one or more antennas (not shown in the FIG. 3) and can support two-way communications between the processor 302 and external devices, as is well understood in the art. The wireless modem 340 is shown generically and can include, for example, a cellular modem 342 for communicating at long range with the mobile communication network, a Wi-Fi compatible modem 344 for communicating at short range with an external Bluetooth-equipped device or a local wireless data network or router, and/or a Bluetooth-compatible modem 346. The wireless modem 340 is typically configured for communication with one or more cellular networks, such as a GSM network for data and voice communications within a single cellular network, between cellular networks, or between the computing device 300 and a public switched telephone network (PSTN).

The computing device 300 can further include one or more input/output ports 350, a power supply 352, one or more sensors 354 for example, an accelerometer, a gyroscope, a compass, or an infrared proximity sensor for detecting the orientation or motion of the computing device 300, a transceiver 356 (for wirelessly transmitting analog or digital signals) and/or a physical connector 360, which can be a USB port, IEEE 1294 (FireWire) port, and/or RS-232 port. The illustrated components are not required or all-inclusive, as any of the components shown can be deleted and other components can be added.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A system (400) for facilitating real time buying of a property, comprising:
a. a server (401), comprising:
i. a real-estate multiple listing service database (407), comprising:
1. at least one property profile (420), comprising data about the at least one property, comprising at least data about a status of “active” or “under contract”, a location, comprising at least GPS coordinates of the property, and instructions for showing the property; and
2. a plurality of agent profiles (430), comprising at least the agent's name and the agent's location;
ii. a processor capable of executing computer instructions, configured to execute computer implemented instructions comprising:
1. instructions for receiving GPS coordinates (202) from a client application of a buyer (416) wherein the GPS coordinates represent the buyer's physical location;
2. instructions for searching the database (407) using the GPS coordinates (203), wherein the search retrieves the data of at least one properties matching the GPS coordinates, wherein the coordinates are matched to within an initial radius;
3. instructions for transmitting the data retrieved by the search about at least one properties to the client application (402) of the buyer;
4. instructions for searching the database for agents available to show the at least one properties, retrieving at least one agent, and transmitting the at least one agents to the client application (402);
5. instructions for receiving an identification of at least one property of interest selected by the client;
6. instructions for interfacing with the client application (402) for receiving contact information from the buyer (405);
7. instructions for interfacing with an agent application (408) to transmit a notification to the agent application that a buyer has requested to see the property of interest;
8. instructions for accepting payment from the agent application (408);
9. instructions for transmitting the contact information of the buyer to the agent application (408); and
10. instructions for retrieving the instructions to show the property of interest from the real-estate multiple listing service database, and transmitting the instructions to the agent application (408);
b. the client application, operatively connected to the server via a network, comprising a user interface (403), comprising:
i. means for the buyer (406) to fetch the GPS coordinates of the buyer, transmit the GPS coordinates of the buyer to the server (202), and receive data about at least one property (203);
ii. means for displaying the data about at least one properties matching the search parameters and/or the GPS coordinates of the buyer at property;
iii. means for a buyer (405) to select a property of interest, transmit the selection of the property of interest to the server; and
iv. means for entering the buyers contact information;
c. the agent application (408) operatively connected to the server via the network, comprising a user interface (409) comprising:
i. means for receiving the notification that a buyer is interested in viewing the property of interest;
ii. means for displaying the property of interest and an option to purchase the buyer's contact information;
iii. means for purchasing the contact information of the buyer (405) in real time, comprising transmitting payment information to the server; and
iv. means for receiving the contact information of the buyer;
wherein when the buyer at a property (406) searches for the property listing at his location the client application retrieves the GPS coordinates of the buyer's location and sends the GPS coordinates to the server;
whereupon the server communicates with the real-estate multiple listing service database (407) to retrieve data about at least one properties matching the GPS coordinates; wherein if there is no property with an active listing within the initial radius of the buyer's location the server searches for properties within a radius of the buyer's location; wherein the server increases the radius until at least one properties are retrieved;
wherein the data about at least one properties is displayed to the buyer at the property (406), wherein the buyer selects at least one properties of interest;
wherein the server searches the database (407) to retrieve a plurality of agents available to show the at least one property;
wherein the server pings at least one agent with a lead of the buyer, wherein the lead of the buyer comprises the buyer's property of interest;
wherein when the agent (410, 412, 414) receives the notification from the server, the agent purchases the contact information of the buyer;
whereupon the server communicates the information of the buyer, instructions to show the property of interest, and a detailed view of the property of interest from the real-estate multiple listing service database to the agent application (408).

2. The system of claim 1, wherein the processor is further configured to execute instructions comprising:
a. instructions for receiving a plurality of search parameters for the property from the client application (420), wherein the search parameters comprise data describing at least one property that the buyer is searching for; and
b. instructions for searching the database using the plurality of search parameters, to retrieve a plurality of properties matching the search parameters;
wherein the client application further (402) comprises:
a. means for a buyer at home (404) to enter a plurality of search parameters for a property (420) to be purchased;
b. means for interfacing with the server (401), to transmit the search parameters and receive data about a plurality of properties from the server; and,
c. means for allowing the buyer to select whether to search using GPS coordinates or search parameters or both;
wherein the buyer at home (404) enters search parameters into the client application (402), whereupon the client application transmits the search parameters to the server (401); wherein the search parameters may include a manually entered GPS location;
wherein the server searches the database (407) for properties with data matching the search parameters; and
wherein the server transmits the data about at least one properties (420) matching the search parameters to the client application (402).

3. The system of claim 1, wherein when displayed by the client application (402), when a status of the property is “active”, the property is indicated by a first color; wherein when the status of the property is “under contract”, the property is indicated by a second color.

4. The system of claim 1, wherein the server searches for agents whose location is in the closest proximity to the location of the property of interest, wherein the server sorts the agents according to distance from the buyer and selects at least one agents according to closest proximity to the buyer.

5. The system of claim 1, wherein the price of the contact information of the buyer varies based on the price of the property.

6. The system of claim 1, wherein the quality of the lead of the buyer determines the price of the lead of the buyer.

7. The system of claim 1, wherein multiple buyers looking in an area on a given time of day also determines the price of the contact information of the buyer.

8. The system of claim 1, wherein when showing the property requires an advance notice, multiple other properties in the area of the property of interest are displayed by the client application.

9. The system of claim 1, wherein the client application further comprises means for adding to the data of the property at least one comments or reviews comprising neighborhood amenities and benefits of the property.

10. The system of claim 1, wherein the agent application (408) further comprises:
a. means for retrieving the agent's profile information (430) from the database and displaying the profile information of the agent;
b. means for editing the profile information about the agent;
c. means for the agent to enter search parameters for searching the database (407);
d. means for interfacing with the server to transmit search parameters to the database and receive the data about at least one properties (420) from the database;
e. means for displaying data about the at least one properties of the database;
f. means for adding at least one piece of market information and reviews of the neighborhood of the property to the data about the at least one property of the database.

11. The system of claim 1, wherein the property profile of the database further comprises a property schedule, wherein the schedule comprises dates and times which are available to show the property and any scheduled showings, wherein the agent profile (430) of the database further comprises an agent schedule, wherein the agent schedule comprises dates and times the agent is available to show properties, and any scheduled showings, wherein the processor of the server (401) is further configured to execute instructions comprising:
a. means for searching the database to retrieve at least one agents available to show the property of interest at a selected date and time, according to the schedule of the agents' profiles;
b. means for transmitting the selected date and time of the property of interest to the agent application, wherein the notification further comprises the selected date and time; and
c. means for adding a scheduled showing to the schedule of the property profile at the selected date and time;
wherein the client application (402) further comprises:
a. means for displaying the property schedule of the property of interest; and
b. means for selecting an available date and time from the schedule;
wherein the agent application (408) further comprises:
a. means for displaying the buyer's selected date and time, wherein the notification to the agent application further comprises the desired showing time;
wherein when the buyer selects a date and time, the date and time and the property of interest are transmitted to the server;
whereupon the server (401) searches the database to identify at least one agents (430) available at the selected date and time;
wherein the server pings the at least one agents with the property of interest and selected date and time;
wherein if the agent purchases the lead of the buyer, the schedule of the property of interest is edited to add the showing.
